(19) United States
(12) Patent Application Publication
(10) Pub. No.: US 2014/0282456 A1
(43) Pub. Date: Sep. 18, 2014

(54) METHODS, SYSTEMS AND COMPUTER-READABLE MEDIA FOR CODE PROFILING AND MIGRATION EFFORT ESTIMATION

(71) Applicant: Cloud Technology Partners, Inc., Boston, MA (US)

(72) Inventors: Bernard A. Drost, Jamaica Plain, MA (US); David C. Knuth, Waltham, MA (US); Jimmy Zhaoming Zhang, Weston, MA (US); Elena A. Grinev, Brookline, MA (US); Erik W. Sebesta, Cambridge, MA (US); Khuong L. Ho, Quincy, MA (US); Thomas J. Kroon, Franklin, MA (US)

(73) Assignee: Cloud Technology Partners, Inc., Boston, MA (US)

(21) Appl. No.: 14/216,212

(22) Filed: Mar. 17, 2014

Related U.S. Application Data
(60) Provisional application No. 61/789,262, filed on Mar. 15, 2013.

(51) Int. Cl. G06F 9/44

(52) U.S. Cl. CPC G06F 8/76
USPC 717/158

(57) ABSTRACT

Systems, methods and computer-readable storage media for profiling software and providing migration effort estimations are described. A software profiling system may be configured to receive code for an application that executes in a first computing environment and analyze the code to determine efforts associated with migrating the application to execute in one or more second computing environments. For instance, the software profiling system may be configured to determine the migration efforts for migrating a software application that operates in a non-cloud computing environment to a cloud computing environment. The software profiling system may generate transformation points that serve as estimation units for solving anomalies identified to bring various aspects of the application into conformance with one or more of the second computing environments. The transformation points may be used to determine an overall migration effort for migrating the application to one or more of the second computing environments.

### CROSS REFERENCE TO RELATED APPLICATIONS

This application claims the benefit of U.S. Provisional Application No. 61/789,262 filed on Mar. 15, 2013, the contents of which are incorporated by reference in their entirety as if fully set forth herein.

### BACKGROUND

Cloud computing services are among the fastest growing segments of the computing technology and services industry. In general, cloud computing (or the “cloud”) includes providing access to computing services and resources over a network, such as the Internet. Illustrative cloud computing services include Software as a Service (SaaS), Infrastructure as a Service (IaaS), and Platform as a Service (PaaS). Consumers and businesses are increasingly relying on the cloud and, as a result, enterprises are progressively migrating applications to operate on cloud-based platforms. However, existing applications can require modifications to program code, modules, libraries, or the like in order to operate, and especially to operate efficiently, in the cloud. In addition, cloud applications must be monitored for inefficiencies, resource utilization, or the like. Currently, determining what must be modified is a costly, time-consuming process involving guesswork and trial-and-error techniques. Accordingly, application developers and cloud enterprises would benefit from a dynamic, automated system for efficiently analyzing application components for migration to the cloud and for robust operation once operating within this environment.

### SUMMARY

The invention described in this document is not limited to the particular systems, methodologies or protocols described, as these may vary. The terminology used herein is for the purpose of describing particular embodiments only, and is not intended to limit the scope of the present disclosure.

It must be noted that as used herein, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

In an embodiment, a system may be configured to analyze the compatibility of software applications for migration from a first computing environment to one or more other computing environments. A computing environment may include, without limitation, characteristics such as software, hardware, and utilization rules. In some embodiments, the first computing environment may include a non-cloud computing environment and the one or more other computing environments may include at least one cloud environment. However, embodiments are not limited to cloud and/or non-cloud computing environments, as the first computing environment and/or the second computing may include any type of computing environment now known to those having ordinary skill in the art or developed in the future.

In some embodiments, the software profiling system may include a set of rules that are applied during an analysis of a software application to determine conformance with a computing environment, such as whether the software application is configured to use certain software libraries that may lead to inefficiencies within the computing environment. According to some embodiments, the software profiling system may use the results of the software analysis to provide an estimation of the effort or costs (“migration effort”) associated with migration and/or to determine which computing environment may be the most appropriate for the software application.

In an embodiment, a software profiling system may include a processor and a non-transitory, computer-readable storage medium in operable communication with the processor. The computer-readable storage medium may contain one or more programming instructions that, when executed, cause the processor to receive code for a first application configured to operate in a first computing environment and to analyze the code for conformance with at least one of a plurality of second computing environments to determine at least one transformation point required to be modified to bring at least one component of the code into conformance with the at least one of the plurality of second computing environments, and generate at least one conformance estimation unit configured to provide an estimation of an effort of modifying the transformation point to be in conformance with the at least one of the plurality of second computing environments. The computer-readable storage medium may also contain one or more programming instructions that, when executed, cause the processor to provide at least one migration effort for migrating the application to the at least one of a plurality of second computing environments based on the at least one conformance estimation unit.

In an embodiment, a computer-implemented method for software profiling may include receiving code for a first application configured to operate in a first computing environment and analyzing the code for conformance with at least one of a plurality of second computing environments. At least one transformation point may be determined that is required to be modified to bring at least one component of the code into conformance with the at least one of the plurality of second computing environments. At least one conformance estimation unit may be generated that is configured to provide an estimation of an effort of modifying the transformation point to be in conformance with the at least one of the plurality of second computing environments. At least one migration effort may be provided for migrating the application to the at least one of a plurality of second computing environments based on the at least one conformance estimation unit.

In an embodiment, a computer-readable storage medium may include computer-readable program code configured to profile software embodied therewith. The computer-readable program code may include computer-readable program code configured to receive code for a first application configured to operate in a first computing environment and configured to analyze the code for conformance with at least one of a plurality of second computing environments. The computer-readable storage medium may also include computer-readable program code configured to determine at least one transformation point required to be modified to bring at least one component of the code into conformance with the at least one of the plurality of second computing environments and to generate at least one conformance estimation unit configured to provide an estimation of an effort of modifying the transformation point to be in conformance with the at least one of the plurality of second computing environments. The computer-readable storage medium may further include computer-readable program code configured to provide at least one migration effort for migrating the application to the at least one of a plurality of second computing environments based on the at least one conformance estimation unit.

### BRIEF DESCRIPTION OF THE DRAWINGS

FIG. 1 depicts at least a portion of a code profiling process according to a first embodiment.

FIG. 2 depicts a flow diagram for an illustrative software profiling method.

FIG. 3 depicts a flow diagram for administering aspects of the software profiling process according to an embodiment.

FIG. 4 depicts a flow diagram for an illustrative method of calculating effort estimation according to an embodiment.

FIG. 5A depicts an illustrative software profiling architecture according to a first embodiment.

FIG. 5B depicts an illustrative software profiling architecture according to a second embodiment.

FIG. 6 depicts an archive profiling process according to an embodiment.

FIG. 7A depicts an illustrative realistic cloud transformation point (CTP) calculation process according to a first embodiment.

FIG. 7B depicts an illustrative realistic cloud transformation point (CTP) calculation process according to a second embodiment.

FIGS. 8A and 8B depict illustrative graphical results elements according to an embodiment.

FIG. 9 depicts a flow diagram for a profiler service method according to an embodiment.

FIG. 10 depicts a block diagram of illustrative internal hardware that may be used to contain or implement program instructions according to an embodiment.

### DETAILED DESCRIPTION

The terminology used in the description is for the purpose of describing the particular versions or embodiments only, and is not intended to limit the scope.

The described technology generally relates to a software profiling and estimation system (the “software profiling system”) configured to determine efforts or costs associated with migrating a software application to one or more computing environments (“migration efforts”). Illustrative and non-restrictive examples of computing environments include utility computing, on-demand infrastructure, cloud computing, network topologies, and/or computing environments characterized, at least in part, by resource or programming language constraints.

Efforts or costs may include, without limitation, time, man hours, resource utilization, resource requirements, financial costs (for example, financial costs of running the application within the computing environment, migrating the application, a combination thereof, or the like), inefficiencies, restructuring costs, infrastructure costs, or the like. In this manner, an application developer or computing environment enterprise may be aware of the amount of effort necessary to migrate software applications to a particular computing environment and to maintain the application thereafter. The migration efforts may include the costs of migrating the application to the particular computing environment (for example, costs for modifying the application) and/or efforts for operating the application in the particular computing environment (for example, greater resource requirements, slower response times, additional infrastructure, or the like). In some embodiments, the migration efforts may include the efforts required to modify (or remediate) an application before migration, the efforts required to actually migrate the application, the efforts or additional costs associated with executing the application in a second computing environment, and/or any combination thereof.

A cloud computing environment (or “the cloud”) may be used as an example in this detailed description, however, embodiments are not so limited as the cloud is used for illustrative purposes only. Any computing environment capable of being used by the software profiling system according to some embodiments is contemplated herein.

According to some embodiments, software profiling principles may be extended with customizable rules governing cloud computing and, more specifically, with a dynamic estimation process configured to calculate the effort, or cost, when application code is migrated to cloud computing platforms. In an embodiment, the dynamic estimation process may use transformation points, such as “cloud transformation points” (CTP) for a cloud computing environment, configured as estimation units for solving anomalies identified to bring various aspects of the software application into conformance. In an embodiment, the software profiling system may be used to determine which cloud computing platform is best suited for the software application, for instance, by calculating a cloud computing conformance rating for one or more cloud computing platforms. In an embodiment, the software profiling system may compare software applications to each other and may compare their performance on various cloud computing platforms. In an embodiment, the software profiling system may be incorporated into a software development life cycle (SDLC) to govern cloud conformance over time. For example, each of the SDLC steps of requirements, development, user acceptance testing (UAT), pre-production, and production may be subjected to static and/or dynamic analysis.

As described in more detail below, the software profiling system may operate to access the code of a software application of interest (for example, by uploading compiled software), profile the code using dynamic cloud computing rules, calculate a cloud conformance rating, calculate effort estimation to move code to a cloud computing platform, and report the findings to a user. The code may include compiled code, uncompiled code, or a combination thereof.

FIG. 1 depicts at least a portion of a code profiling process according to a first embodiment. As shown in FIG. 1, a software profiling process may include cloud characteristics 105, such as customizable rules governing the cloud computing platform and one or more specific application software languages (for example, Java®, NET, PHP, Python, Ruby, Perl, Unix, Solaris, AIX, C#, C++, C, or combinations thereof). One or more applications 110a-110c may be analyzed to determine various conformance characteristics, such as anomalies 115, migration effort estimation 130, and repeated migration anomalies that may allow for economies of scale 135. The conformance characteristics may be used, among other things, by the process to determine a total effort required 140 to migrate the software application to the cloud.

In an embodiment, the software profiling system may be configured to migrate anomalies 115 to cloud conformance. In an embodiment, based on repeated migration of anomalies, a curve, such as a three-point curve, may be established to determine a migration effort for a first set of X anomalies 115, a migration effort for a second set of anomalies between X and Y, and so on, to determine a total migration effort.

The rules may include various instructions, guidelines, directives, requirements, restrictions, limitations, or the like. In an embodiment, one or more of the rules may be specific for a particular programming language, platform, computing devices, or the like. Illustrative and non-restrictive examples of rules associated with a programming language (for example, Java®), including avoiding the use of certain libraries, avoiding reading, writing or otherwise interacting with data from particular devices (for example, local devices), use of efficient programming principles, garbage collection, resource utilization, or the like. In an embodiment, the rules may be weighted and/or categorized (for example, minor, major, or the like) and may be handled accordingly. For example, the requirement to trigger an event may include, a predetermined number of minor rule violations, only one major rule violation, a predetermined weight of violations (determined by adding up their weights), or any combinations thereof.

The software profiling process may be configured based on, among other things, rule sets and decision-making processes for determining which applications should be preferred at a cloud computing platform, processes for handling applications with low code quality and high complexity that need to evolve, and determinations of when a custom legacy infrastructure is no longer viable. Software profiling tools may be selected and implemented, such as, for code profiling. The code may be profiled to identify rule violations, and a refactoring pattern may be defined for each violation.

FIG. 2 depicts a flow diagram for an illustrative software profiling method. As shown in FIG. 2, if software is compiled 201, the compiled source code may be uploaded 202, and the system may operate to decompile 203 the compiled source code. If the software is not compiled 201, a user may identify the source code location 204 for the code that will be analyzed. The user may choose a cloud computing platform 205, and the software profiling system may profile the source code 206, calculate a cloud conformance rating 207, and calculate an estimation effort 208. The cloud conformance rating 207 may include the conformance of the code with the cloud platform, for example, pertaining to software language, the particular software constructs, routines, libraries, or the like used in the code, and/or resource utilization. The estimation effort 208 may include the costs associated with migrating the software application to the cloud, including, without limitation, the amount of changes that will be required, financial and time costs, or the like. The software profiling system will report 209 these results to the user, for example, through a graphical user interface (GUI), reporting mechanisms, or the like.

FIG. 3 depicts a flow diagram for administering aspects of the software profiling process according to an embodiment. As shown in FIG. 3, an administrator (for example, a cloud administrator, operating entity, or the like) may analyze a cloud computing platform 305 or other computing environment. A set of cloud computing rules 310 may be created for the cloud computing platform, such as rules involving programming languages, hardware compatibility, or the like. The administrator may also create cloud computing estimation efforts 315 configured to estimate the costs associated with migrating to the cloud computing platform.

FIG. 4 depicts a flow diagram for an illustrative method of calculating effort estimation according to an embodiment. As shown in FIG. 4, logical single lines of code (SLOC) 401, code coverage 402, and the number of violations 403 may be used to determine complexity 404 of the code. Redesign elements 407, category 405, and the complexity 404 of the code may be used to determine CTP 406, which may be used to determine unadjusted CTP 408. Interdependencies 409 and topology 410 may be used to determine a variable adjustment factor (VAF) or “Team Metrics” factor 411. Accelerators 412, unadjusted CTP 408, and the Team Metrics factor 411 may be used to determine an adjusted CTP 413. An accelerator 412 may include, but is not limited to, design patterns, development skills, shared refactoring components, shared testing processes and environments, and/or experienced project management in cloud development life cycle.

When source code is profiled, a determination may be made involving how complex 404 the code is. This may be determined based on, among other things, the number of single lines of code (SLOC) 401, the number of test cases that cover the source code (code coverage) 402, and the number of rule violations that were identified by profiling the code. CTP 406 may then be determined by taking the complexity of each violation, the violation category (for example, major, minor, or the like) 405, and if redesign elements 407 are available. All CTP may be summed across all violations producing an unadjusted CTP, for example, as provided in CTP 408. Interdependencies 409 and topology 410 may be used to determine a VAF or Team Metrics factor 411. Accelerators 412, unadjusted CTP 408 and the Team Metrics factor 411 may be used to determine an adjusted CTP 413. An accelerator 412 may include, but is not limited to, design patterns, development skills, shared refactoring components, shared testing processes and environments, and/or experienced project management in cloud development life cycle.

A test factor 414 and/or a human factor 415 may be used to determine a realistic CTP 416 from the adjusted CTP 413. The test factor 414 may include, without limitation, existing functionality regression testing, regression testing of re-factored components, preparation efforts for testing (for example, new use cases, new test cases, testing tool/data, subject matter expertise (SME), and/or other simulation characteristics), test coverage requirements, additional coverage for performance, stability, and/or security. The human factor 415 may include a standard CTP (for instance, 1 developer day), for example, 8 hours a day at an average productivity percentage of 70%, totaling about 180 days annually. CTP may be expressed in terms of average productivity of a developer to refactor legacy code to cloud compliant code, including familiarity with the cloud design patterns and overall experience refactoring legacy code. The human factor may express the difference in the above factors to conventional circumstances. Optimistic CTP 419 and pessimistic CTP 420 values may be determined from the realistic CTP 416, for example, based on an optimistic percentage factor 417 and a pessimistic percentage factor 418.

According to some embodiments, each Team Metrics factor 411 may be provided a weight indicative of its importance in migrating an application to the cloud. The following table provides illustrative and non-restrictive Team Metrics factor 411 weights:

| # | Team Metrics Category | Weight | Score | Total |
|---|---|---|---|---|
| 1 | Data Communications | 100% | 1 | 1 |
| 2 | Performance | 50% | 5 | 2.5 |
| 3 | Latency | 200% | 4 | 8 |

For each application, each factor may be provided a score based on one or more criteria, such as the following scale: “no impact” (score=0); “incidental impact” (score=1); “moderate impact” (score=2); “average impact” (score=3); “significant” (score=4); “strong impact” (score=5). A scale, such as the scale described above, may be configured, among other things, to provide a manual overlay to the computation of finding violations and applying effort. When each factor has a final score, all of the scores may be summed and applied to the unadjusted CTP 408 to determine the adjusted CTP 413, along with other factors.

FIG. 5A depicts an illustrative software profiling architecture according to a first embodiment. As shown in FIG. 5A, software profiling architecture may include components segmented into a cloud layer 502 and a desktop/enterprise layer 504. The cloud layer 502 may include a web application and database 552 configured to store data and to provide various services. For example, customer specific data may be stored in a database of cloud 552. User authentication/authorization may be performed against the cloud 552. A profiler instance 514 may include a set of services for profiling as a service, which may be increased or decreased based on system performance metrics.

Data, such as non-identifiable data 512, may be stored in an analytics data store 506 accessible by the web application and database 552. A rules service component 508 may use rule meta-data 510 and rules associated therewith may be replicated to profiler instances 514 and cached for fast profiling. An agent 530 may operate in the cloud layer 502, for example, as an agent for uploading code 540 to start a user profile, for instance, through a web browser 546 in the desktop/enterprise layer 504. The agent 530 may obtain archive data 532 from an object store 526. In an embodiment, the object store 526 may include a network-attached storage and/or network file store system and may store content temporarily. The agent 530 may perform extraction and/or preprocessing, which may be stored in the object store 526. The cloud 552 may be configured to provide reporting features 542 to the desktop/enterprise layer 504. Source code may be uploaded to the agent 530 through various components in the desktop/enterprise layer 504. For example, code may be uploaded 536 from continuous integration servers 538. Alternately, or additionally, code may be uploaded 540 from a web browser 546. Code may also be uploaded 534 from various other types of devices, such as integrated development environment (IDE)-based devices 544.

FIG. 5B depicts an illustrative software profiling architecture according to a second embodiment. As shown in FIG. 5B, the components of the software profiling architecture may be segmented into different layers, such as a cloud layer 502, an enterprise layer 548, and a desktop layer 550.

FIG. 6 depicts an archive profiling process according to an embodiment. As shown in FIG. 6, the archive profiling process may include user 602, cloud application 604, agent module 606 PaaSLane agent, and process instance elements 608. The archive profiling process may include steps of: archive upload 610, processing 612, and status check 614.

A user 602 may request 616 and receive authentication 618 from the cloud application 604. The user 602 may upload an archive 620, which may be encrypted and stored 622. The agent module 606 may query health & status (H&S) 624, which may be returned 626 from the process instance 608. The agent module 606 may submit a profile request 632 and may return a profile ticket 628 to the cloud application 604. The user 602 may receive an accepted profile returned 630 from the cloud application 604.

During processing 612, the process instance 608 may process 634 the request and send a profile status update 636 to the agent module 606. The agent module 606 may send a profile status 638 with results to the cloud application 604.

During status checks 614, the cloud application 604 may query H&S 640, and the agent module 606 may return H&S 642. The user 602 may query a profile status 644, and the cloud application 604 may return a profile status 646 to the user.

FIG. 7A depicts an illustrative realistic CTP calculation process according to a first embodiment. As shown in FIG. 7A, the realistic CTP may be calculated using a realistic CTP calculation process 702 including, among other things, CTP 704, Team Metrics factor 706, test factor 708, and human factor 710 components. FIG. 7B depicts an illustrative realistic CTP calculation process according to a second embodiment. As shown in FIG. 7B, the realistic CTP may be calculated using a realistic CTP calculation process 712 including, among other things, base factor 714, Team Metrics factor 716, test factor 708, and human factor 710 components. According to some embodiments, the realistic CTP (estimate) may be configured to represent compliance to cloud principles, minor redesigns, code quality, code refactoring, test cases on refactoring, and/or an accelerator factor. Refactoring may include, generally, restructuring existing code to modify its internal structure without changing its overall functionality.

The software profiling system may be used during various phases of software migration from one computing environment to another. In a pre-migration phase, the software profiling system may be configured to, among other things, determine and prioritize which applications might be good migration candidates, build an internal business case for migration, and compare the costs required to migrate to different platforms (for example, multiple PaaS platforms), and determine the best suited platform (for example, lowest-effort of migration) for each application. In a migrating phase, the software profiling system may be configured to, among other things, determine where and what to refactor, and best practices to accelerate migration. In a post-migration phase (an “ongoing governance and compliance check” phase), the software profiling system may be configured to, among other things, check compliance to cloud and SDLC standards when upgrading/changing applications, maintain platform (for example, PaaS) compatibility, incorporate standards into the daily build process, and configure custom rules.

According to some embodiments, the software profiling system may be configured to operate according to one or more guidelines. For example, a source code/binaries guideline may include adherence to cloud principles, functional component decomposition, and/or mapping to a service registry. In another example, a testing guideline may include SLA and OLA, SME) and documentation availability, access to test data and test cases, and parallel/load/penetration testing requirements. In a further example, an interdependencies guideline may include interfaces, data feeds, topology/architecture/cluster analysis, and/or application usage.

According to some embodiments, the software profiling system generally operates by: allowing a user to select a configurable, pre-defined rule set for a platform, application and/or enterprise; loading program code into the software profiling system engine (for example, the calculation process 702 of FIG. 7); generating profiling and estimation results; and presenting the results to a user. FIGS. 8A and 8B depict illustrative graphical results elements according to an embodiment. For example, FIG. 8A depicts a conformance rating while FIG. 8B depicts a CTP values and associated percentages.

FIG. 9 depicts a flow diagram for a profiler service method according to an embodiment. As shown in FIG. 9, the profiler service may include a profile request queue 905, which may receive requests and unpack 910 and decompile 915 code associated with the requests. A ready work queue 920 may be configured to generate multiple profiles 925a-925c based on the requests.

FIG. 10 depicts a block diagram of illustrative internal hardware that may be used to contain or implement program instructions according to an embodiment. A bus 1000 serves as the main information highway interconnecting the other illustrated components of the hardware. CPU 1005 is the central processing unit of the system, performing calculations and logic operations required to execute a program. CPU 1005, alone or in conjunction with one or more of the other elements, is an exemplary processing device, computing device or processor as such terms are using in this disclosure. Read only memory (ROM) 1010 and random access memory (RAM) 1015 constitute exemplary memory devices.

A controller 1020 interfaces with one or more optional memory devices 1025 to the system bus 1000. These memory devices 1025 may include, for example, an external or internal DVD drive, a CD ROM drive, a hard drive, flash memory, a USB drive or the like. As indicated previously, these various drives and controllers are optional devices.

Program instructions, software or interactive modules for providing the digital marketplace and performing analysis on any received feedback may be stored in the ROM 1010 and/or the RAM 1015. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface 1030 may permit information from the bus 1000 to be displayed on the display 1035 in audio, visual, graphic or alphanumeric format. Communication with external devices may occur using various communication ports 1090. An exemplary communication port 1090 may be attached to a communications network, such as the Internet or an intranet. Other exemplary communication ports 1090 may comprise a serial port, a RS-232 port, and a RS-485 port.

The hardware may also include an interface 1095 which allows for receipt of data from input devices such as a keyboard 1050 or other input device 1055 such as a mouse, a touch screen, a remote control, a pointing device, a video input device and/or an audio input device.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by this detailed description.

What is claimed is:

1. A software profiling system comprising:
a processor; and
a non-transitory, computer-readable storage medium in operable communication with the processor, wherein the computer-readable storage medium contains one or more programming instructions that, when executed, cause the processor to:
receive code for a first application configured to operate in a first computing environment,
analyze the code for conformance with at least one of a plurality of second computing environments to:
determine at least one transformation point required to be modified to bring at least one component of the code into conformance with the at least one of the plurality of second computing environments, and
generate at least one conformance estimation unit configured to provide an estimation of an effort of modifying the transformation point to be in conformance with the at least one of the plurality of second computing environments, and
provide at least one migration effort for migrating the application to the at least one of a plurality of second computing environments based on the at least one conformance estimation unit.

2. The system of claim 1, wherein the computer-readable storage medium contains one or more programming instructions that, when executed, cause the processor to generate at least one operation estimation unit configured to provide an estimation of the efforts associated with operating the application in the at least one of the plurality of second computing environments.

3. The system of claim 2, wherein the at least one migration effort is based on the at least one conformance estimation unit and the at least one operation estimation unit.

4. The system of claim 1, wherein the plurality of second computing environments comprise at least one of a utility computing environment, an on-demand infrastructure environment, a cloud computing environment, a non-cloud computing environment, and a network topology environment.

5. The system of claim 1, wherein the first computing environment comprises a non-cloud computing environment and the at least one of the plurality of second computing environments comprises a cloud computing environment.

6. The system of claim 1, wherein the computer-readable storage medium contains one or more programming instructions that, when executed, cause the processor to compare at least two migration efforts for migrating the application to at least two of the plurality of second computing environments.

7. The system of claim 6, wherein the plurality of second computing environments comprise a first cloud computing environment and a second cloud computing environment,
wherein the computer-readable storage medium contains one or more programming instructions that, when executed, cause the processor to determine which of the first cloud computing environment and the second cloud computing environment are lowest-effort for migrating the application based on the comparison of the at least two migration efforts.

8. The system of claim 1, wherein the at least one migration effort comprises at least one of time, man hours, resource utilization, resource requirements, financial costs, inefficiencies, restructuring costs, and infrastructure costs.

9. A computer-implemented method for software profiling, the method comprising, by a processor:
receiving code for a first application configured to operate in a first computing environment;
analyzing the code for conformance with at least one of a plurality of second computing environments;
determining at least one transformation point required to be modified to bring at least one component of the code into conformance with the at least one of the plurality of second computing environments;
generating at least one conformance estimation unit configured to provide an estimation of an effort of modifying the transformation point to be in conformance with the at least one of the plurality of second computing environments; and
providing at least one migration effort for migrating the application to the at least one of a plurality of second computing environments based on the at least one conformance estimation unit.

10. The computer-implemented method of claim 9, further comprising, by the processor, generating at least one operation estimation unit configured to provide an estimation of the efforts associated with operating the application in the at least one of the plurality of second computing environments.

11. The computer-implemented method of claim 10, wherein the at least one migration effort is based on the at least one conformance estimation unit and the at least one operation estimation unit.

12. The computer-implemented method of claim 9, wherein the plurality of second computing environments comprise at least one of a utility computing environment, an on-demand infrastructure environment, a cloud computing environment, a non-cloud computing environment, and a network topology environment.

13. The computer-implemented method of claim 9, wherein the first computing environment comprises a non-cloud computing environment and the at least one of the plurality of second computing environments comprises a cloud computing environment.

14. The computer-implemented method of claim 9, further comprising, by the processor, comparing at least two migration efforts for migrating the application to at least two of the plurality of second computing environments.

15. The computer-implemented method of claim 9, wherein the at least one migration effort comprises at least one of time, man hours, resource utilization, resource requirements, financial costs, inefficiencies, restructuring costs, and infrastructure costs.

16. A computer-readable storage medium having computer-readable program code configured to profile software embodied therewith, the computer-readable program code comprising:
computer-readable program code configured to receive code for a first application configured to operate in a first computing environment;
computer-readable program code configured to analyze the code for conformance with at least one of a plurality of second computing environments;
computer-readable program code configured to determine at least one transformation point required to be modified to bring at least one component of the code into conformance with the at least one of the plurality of second computing environments;
computer-readable program code configured to generate at least one conformance estimation unit configured to provide an estimation of an effort of modifying the transformation point to be in conformance with the at least one of the plurality of second computing environments; and
computer-readable program code configured to provide at least one migration effort for migrating the application to the at least one of a plurality of second computing environments based on the at least one conformance estimation unit.

17. The computer-readable storage medium of claim 16, wherein the plurality of second computing environments comprise at least one of a utility computing environment, an on-demand infrastructure environment, a cloud computing environment, a non-cloud computing environment, and a network topology environment.

18. The computer-readable storage of claim 16, wherein the first computing environment comprises a non-cloud computing environment and the at least one of the plurality of second computing environments comprises a cloud computing environment.

19. The computer-readable storage medium of claim 16, further comprising computer readable program code configured to compare at least two migration efforts for migrating the application to at least two of the plurality of second computing environments.

20. The computer-readable storage medium of claim 16, wherein the at least one migration effort comprises at least one of time, man hours, resource utilization, resource requirements, financial costs, inefficiencies, restructuring costs, and infrastructure costs.
